(19) United States
(12) Patent Application Publication
(10) Pub. No.: US 2023/0046088 A1
(43) Pub. Date: Feb. 16, 2023

(54) METHOD FOR TRAINING STUDENT NETWORK AND METHOD FOR RECOGNIZING IMAGE

(71) Applicant: BEIJING BAIDU NETCOM SCIENCE TECHNOLOGY CO., LTD., Beijing (CN)

(72) Inventors: Tianyi Wu, Beijing (CN); Yu Zhu, Beijing (CN); Guodong Guo, Beijing (CN)

(73) Assignee: BEIJING BAIDU NETCOM SCIENCE TECHNOLOGY CO., LTD., Beijing (CN)

(21) Appl. No.: 17/975,874

(22) Filed: Oct. 28, 2022

(30) Foreign Application Priority Data
Oct. 29, 2021 (CN) 202111271677.5

(51) Int. Cl. G06V 10/77; G06V 10/774

(52) U.S. Cl. CPC G06V 10/7715; G06V 10/774

(57) ABSTRACT

Disclosed are a method for training a Student Network and a method for recognizing an image. The method includes: acquiring first prediction feature information of a sample image on the first granularity and second prediction feature information of the sample image on the second granularity by inputting the sample image into a Student Network, and acquiring first feature information of the sample image on the first granularity and second feature information of the sample image on the second granularity by inputting the sample image into a Teacher Network, and acquiring a target Student Network.

### CROSS REFERENCE TO RELATED APPLICATIONS

This application is based on and claims priority to Chinese patent applications Serial No. 202111271677.5 filed on Oct. 29, 2021, the entire contents of which are incorporated herein by reference.

### TECHNICAL FIELD

The disclosure relates to a field of an image processing technology, and more specifically to a field of an artificial intelligence technology, and specifically to fields of deep learning and computer vision technologies.

### BACKGROUND

An image recognition technology is widely applied in daily life with the rapid development of image processing technologies. Image recognition refers to a technology for recognizing various different targets and objects by using a computer to process, analyze and understand images, which is a practical application for applying a deep learning algorithm. Generally, in the field of an image recognition technology, a trained model/network for image recognition is generally used to recognize an image to be recognized to acquire a recognition result.

Therefore, it has become one of the important research directions how to improve a training effect of an image recognition network to recognize an image to be recognized through the trained image recognition network more accurately.

### SUMMARY

A method for training a Student Network and a method for recognizing an image are provided in the disclosure.

According to one aspect of the disclosure, a method for training a Student Network is provided, and includes: acquiring first prediction feature information of a sample image on a first granularity and second prediction feature information of the sample image on a second granularity by inputting the sample image into a Student Network, in which the first granularity is different from the second granularity; acquiring first feature information of the sample image on the first granularity and second feature information of the sample image on the second granularity by inputting the sample image into a Teacher Network; and acquiring a target Student Network by adjusting the Student Network based on the first prediction feature information, the second prediction feature information, the first feature information and the second feature information.

According to another aspect of the disclosure, a method for recognizing an image is provided, and includes: acquiring an image to be recognized; and outputting an image recognition result of the image by inputting the image into a target Student Network, in which the target Student Network is acquired by the method for training a Student Network as described in a first aspect of embodiments.

According to another aspect of the disclosure, an electronic device is provided, and includes: at least one processor; and a memory communicatively connected to the at least one processor; the memory is stored with instructions executable by the at least one processor, the instructions are performed by the at least one processor, the at least one processor is caused to perform the method for training a Student Network as described in the first aspect of the disclosure or the method for recognizing an image as described in the second aspect of the disclosure.

According to another aspect of the disclosure, a non-transitory computer readable storage medium stored with computer instructions is provided. The computer instructions are configured to cause a computer to perform the method for processing data as described in the first aspect or the method for processing data as described in the second aspect.

According to another aspect of the disclosure, a computer program product including a computer program is provided, the computer program achieves the method for training a Student Network as described in the first aspect or the method for recognizing an image as described in the second aspect when performed by a processor.

It should be understood that, the content described in the part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand the solution, and do not constitute a limitation to the disclosure.

FIG. 1 is a flow chart illustrating a method for training a Student Network according to a first embodiment of the disclosure;

FIG. 2 is a flow chart illustrating a method for training a Student Network according to a second embodiment of the disclosure;

FIG. 3 is a flow chart illustrating a method for training a Student Network according to a third embodiment of the disclosure;

FIG. 4 is a flow chart illustrating a method for training a Student Network according to a fourth embodiment of the disclosure;

FIG. 5 is a flow chart illustrating a method for recognizing an image according to a fifth embodiment of the disclosure;

FIG. 6 is a schematic diagram illustrating an image recognition system;

FIG. 7 is a schematic diagram illustrating feature extraction;

FIG. 8 is a diagram illustrating another feature extraction module;

FIG. 9 is a block diagram illustrating an apparatus for training a Student Network configured to perform a method for training a Student Network according to an embodiment of the disclosure;

FIG. 10 is a block diagram illustrating an apparatus for recognizing an image configured to implement a method for recognizing an image according to an embodiment of the disclosure;

FIG. 11 is a block diagram of an electronic device configured to implement a method for training a Student Network and a method for recognizing an image according to an embodiment of the disclosure.

### DETAILED DESCRIPTION

The exemplary embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made to the embodiments described herein without departing from the scope and spirit of the present disclosure. Similarly, for clarity and conciseness, descriptions of well-known functions and structures are omitted in the following descriptions.

The technical fields referred to in the disclosure are briefly introduced as below:

Image processing is a technology for analyzing an image by a computer to achieve a desired result. It is also referred to as photograph and picture processing. Image processing generally refers to digital image processing. A digital image refers to a large two-dimensional array shot by a device such as an industrial camera, a photographer, a scanner. The element of the array is referred to as a pixel, and the value thereof is referred to as a gray value. Image processing technology generally includes image compression, enhancement and restoration, matching, description and recognition.

Artificial intelligence(AI) is a subject that studies simulating certain thinking processes and intelligent behaviors (such as learning, reasoning, thinking, planning, etc.) of human beings by a computer, which covers hardware-level technologies and software-level technologies. AI hardware technologies generally include computer vision technology, voice recognition technology, natural language processing (NLP) technology and its learning/ deep learning (DL), big data processing technology, knowledge graph technology, etc.

Deep learning (DL) is a new research direction in the field of machine learning (referred to as ML). DL is introduced in ML to make it closer to an original target-artificial intelligence (AI). DL learns inherent law and representation hierarchy of sample data, and information obtained in the learning process is of great help in interpretation of data such as words, images and sound. Its final goal is that the machine may have analytic learning ability like humans, which may recognize data such as words, images, sound, etc.

Computer vision is a science that studies how to make a machine “look”, and further refers to performing machine vision such as recognition, tracking and measurement on a target by a camera and a computer instead of human eyes, and further performing graphics processing, so that it may be processed by a computer into an image more suitable for human eyes to observe or transmitted to an instrument for detection. As a science subject, theories and technologies related to computer vision research attempt to establish an artificial intelligence system for acquiring “information” from an image or multi-dimensional data.

A method for training a Student Network in the embodiment of the disclosure is described with reference to attached drawings.

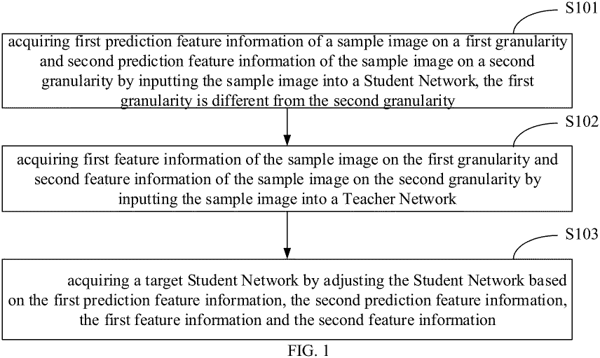

FIG. 1 is a flow chart illustrating a method for training a Student Network according to a first embodiment of the disclosure. It should be noted that, an execution subject of the method for training a Student Network in the embodiments may be an apparatus for training a Student Network. The apparatus for training a Student Network may be specifically a hardware device or a software in a hardware device, etc. The hardware device may be a terminal device, a server, etc.

As illustrated in FIG. 1, the method for training a Student Network provided in the embodiment includes the following blocks.

At block S101, first prediction feature information of a sample image on a first granularity and second prediction feature information of the sample image on a second granularity are acquired by inputting the sample image into a Student Network. The first granularity is different from the second granularity.

It needs to be noted that, in the field of an image recognition technology, a self-supervised learning method is generally adopted to train a model/network for recognizing an image, and an image to be recognized is recognized based on a converged model/network for recognizing an image to acquire a recognition result.

In the related art, mainstream self-supervised learning methods may be divided into the following two categories.

A first one is a training method based on contrastive learning. Optionally, coarse-grained representations of the same image under two data enhancements are regarded as positive pairs, and coarse-grained representations of different images under a data enhancement are regarded as negative pairs. Representations of the same image under two data enhancements are taken as positive pairs, a distance between them is as small as possible, and representations of different images under the data enhancement are as far as possible.

However, the above method needs to rely on a very large memory bank or a very large hyper-parameter, that is, a batch size, which is not friendly for a video memory. That is to say, a large number of samples need to be adopted to participate in training.

A second one is a method for performing representation learning without a negative sample. Optionally, an asymmetric predictor network and Stop-gradients may be adopted to avoid collapsed representations. For example, a regularization term may be introduced to constrain the cross-correlation matrix output by two identical networks as an identity matrix.

However, there are obvious problems in the two methods, that is, a method for extracting a coarse-grained feature only may focus on a salient region to acquire a region-level feature of the image, but ignore other important regions of the image, thereby causing an inaccurate image recognition result.

Therefore, a network framework of a Student network and a Teacher network framework both having a feature extraction module with a first granularity and a feature extraction module with a second granularity may be adopted in the disclosure to acquire a target Student Network by training a Student Network.

In the embodiment of the disclosure, first prediction feature information of the sample image on a first granularity and second prediction feature information of the sample image on a second granularity may be acquired by inputting the sample image into a Student Network, the first granularity is different from the second granularity.

The sample images may be any image to be recognized, and the number of sample images is not limited, and may be set based on an actual situation.

The first prediction feature information is a prediction result of first feature information output by the Teacher Network, and the second prediction feature information is a prediction result of second feature information output by the Teacher Network.

Granularity sizes of the first granularity and the second granularity are different, optionally, the first granularity may be set to a coarse granularity, and the second granularity is set to a fine granularity; optionally, the first granularity may be set to a fine granularity, and the second granularity is set to a coarse granularity.

It should be noted that, when feature extraction is performed on an image using different granularities, the acquired features are also different. Optionally, a region-level feature may be acquired by performing feature extraction on an image using a coarse granularity; optionally, a pixel-level feature may be acquired by performing feature extraction on an image using a fine granularity. The pixel-level feature refers to a feature obtained by performing feature extraction on each pixel in any image frame.

At block S102, first feature information of the sample image on the first granularity and second feature information of the sample image on the second granularity are acquired by inputting the sample image into a Teacher Network.

In the embodiment of the disclosure, when the first prediction feature information of the sample image on the first granularity and the second prediction feature information of the sample image on the second granularity are acquired by inputting the sample image into the Student Network, the first feature information of the sample image on the first granularity and the second feature information of the sample image on the second granularity may be acquired by inputting the sample image into the Teacher Network.

It needs to be noted that, the feature information of the sample image respectively acquired by the Student Network and the Teacher Network may be different.

Further, the Student Network may be trained based on the first prediction feature information and the second prediction feature information of the sample image under one data enhancement acquired by the Student Network in combination with the first feature information and the second feature information of the sample image under another data enhancement acquired by the Teacher Network.

At block S103, a target Student Network is acquired by adjusting the Student Network based on the first prediction feature information, the second prediction feature information, the first feature information and the second feature information.

In the embodiment of the disclosure, after the first prediction feature information, the second prediction feature information, the first feature information and the second feature information are acquired, a first difference between the first prediction feature information and the first feature information and a second difference between the second prediction feature information and the second feature information may be acquired, a loss function may be acquired based on the first difference and the second difference and the Student Network is adjusted based on the loss function to acquire the target Student Network.

Based on the method for training a Student Network in the embodiment of the disclosure, first prediction feature information of the sample image on a first granularity and second prediction feature information of the sample image on a second granularity are acquired by inputting the sample image into a Student Network, and first feature information of the sample image on the first granularity and second feature information of the sample image on the second granularity are acquired by inputting the sample image into a Teacher Network, and further a target Student Network is acquired by adjusting the Student Network based on the first prediction feature information, the second prediction feature information, the first feature information and the second feature information, so that the trained target Student Network may acquire a region-level feature of the image by focusing on a salient region, and further may acquire a pixel-level feature of the image, which avoids an inaccurate image recognition result caused due to ignoring other important regions of the image and improves a training effect of the Student Network.

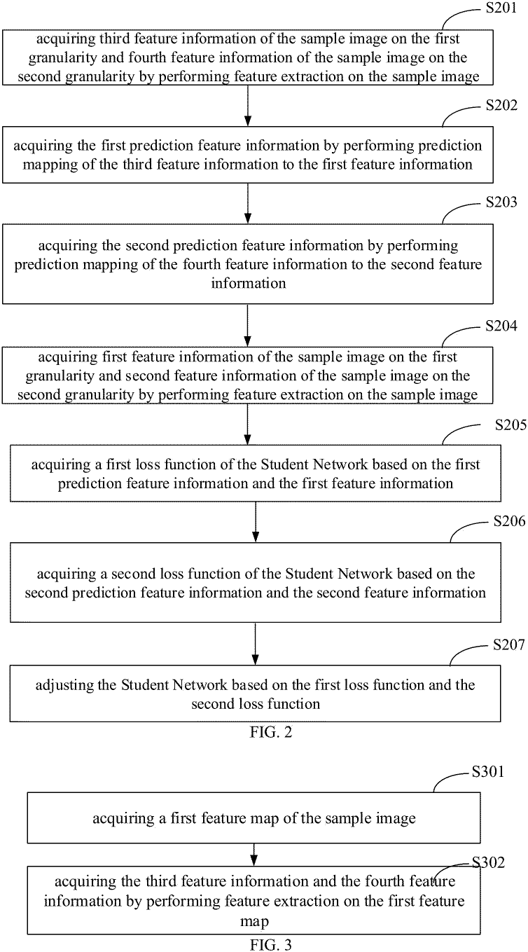

FIG. 2 is a flow chart illustrating a method for training a Student Network according to a second embodiment of the disclosure.

As illustrated in FIG. 2, the method for training a Student Network provided in the embodiment includes the following blocks.

The block S101 may include the following blocks S201-S203.

At block S201, third feature information of the sample image on the first granularity and fourth feature information of the sample image on the second granularity are acquired by performing feature extraction on the sample image.

In the embodiment of the disclosure, different granularities may be adopted to perform feature extraction on the sample image after the sample image is input into the Student Network. Optionally, the third feature information may be acquired by performing feature extraction on the sample image using the first granularity and the fourth feature information may be acquired by performing feature extraction on the sample image using the second granularity.

For example, for a sample image X, when the sample image X is input into the Student Network, third feature information y₁^{c} may be acquired by performing feature extraction on the sample image X using the first granularity and fourth feature information y₁^{f} may be acquired by performing feature extraction on the sample image X using the second granularity.

At block S202, the first prediction feature information is acquired by performing prediction mapping of the third feature information to the first feature information.

In the embodiment of the disclosure, after the third feature information is acquired, the first prediction feature information may be acquired by performing prediction mapping of the third feature information to the first feature information using modules such as a predictor.

For example, after the third feature information y₁^{c} is acquired, the first prediction feature information q^{c} may be acquired by performing prediction mapping of the third feature information y₁^{c} to the first feature information.

At block S203, the second prediction feature information is acquired by performing prediction mapping of the fourth feature information to the second feature information.

In the embodiment of the disclosure, after the fourth feature information is acquired, the second prediction feature information may be acquired by performing prediction mapping of the fourth feature information to the second feature information using modules such as a predictor.

For example, after the fourth feature information y₁^{f} is acquired, the second prediction feature information q^{f} may be acquired by performing prediction mapping of the fourth feature information y₁^{f} to the second feature information.

The block S102 may include the following block S204.

At block S204, the first feature information of the sample image on the first granularity and the second feature information of the sample image on the second granularity are acquired by performing feature extraction on the sample image.

In the embodiment of the disclosure, the first feature information and the second feature information of the sample image may be acquired by performing feature extraction on the sample image.

In the embodiment of the disclosure, for a sample image X, the first feature information y₂^{c} and the second feature information y₂^{f} of the sample image X may be acquired by performing feature extraction on the sample image X.

The block S103 may include the following blocks S205-S207.

At block S205, a first loss function of the Student Network is acquired based on the first prediction feature information and the first feature information.

In the embodiment of the disclosure, the first loss function of the Student Network may be acquired based on the first prediction feature information and the first feature information by the following formula:

$${L}_{c} \left({q}_{c} , {y}_{2}^{c}\right) = {\left‖{q}_{c} - {y}_{2}^{c}\right‖}_{2}^{2} = 2 - 2 ⋅ \frac{\left({q}_{c} , {y}_{2}^{c}\right)}{{\left‖{q}_{c}\right‖}_{2} ⋅ {\left‖{y}_{2}^{c}\right‖}_{2}}$$

where, L_{c} is the first loss function, q^{c} is the first prediction feature information, and y₂^{c} is the first feature information. The first loss function L_{c} is a minimum mean square error between a coarse-grained feature from the Teacher Network and a prediction of the Student Network on the feature.

At block S206, a second loss function of the Student Network is acquired based on the second prediction feature information and the second feature information.

In the embodiment of the disclosure, the second loss function of the Student Network may be acquired based on the second prediction feature information and the second feature information by the following formula:

$${L}_{f} \left({q}_{f} , {y}_{2}^{f}\right) = {\left‖{q}_{f} - {y}_{2}^{f}\right‖}^{2} {}_{2} = 2 - 2 ⋅ \frac{\left〈{q}_{f} , {y}_{2}^{f}\right〉}{{\left‖{q}_{f}\right‖}_{2} ⋅ {\left‖{y}_{2}^{f}\right‖}_{2}}$$

where, Lf is the second loss function, q^{f} is the second prediction feature information, and y₂^{f} is the second feature information. The second loss function Lf is a minimum mean square error between a fine-grained feature from the Teacher Network and a prediction of the Student Network on the feature.

At block S207, the Student Network is adjusted based on the first loss function and the second loss function.

In the embodiment of the disclosure, after the first loss function and the second loss function are acquired, the first loss function and the second loss function may be weighted, and the weighted result may be configured as a loss function of the Student Network to adjust the Student Network.

For example, for the first loss function L_{c} and the second loss function Lf, the loss function L of the Student Network may be acquired by the following formula:

$$L = {L}_{c} \left({q}_{c} , {y}_{2}^{c}\right) + α {L}_{f} \left({q}_{f} , {y}_{2}^{f}\right)$$

where, α is a weight, and may be set based on actual situations.

The specific processes of acquiring the first feature information, the second feature information, the third feature information and the fourth feature information are described respectively.

For acquiring the third feature information and the fourth feature information, as a possible implementation, as illustrated in FIG. 3, on the basis of the above embodiments, the method specifically includes the following blocks.

At block S301, a first feature map of the sample image is acquired.

In the embodiment of the disclosure, the first feature map of the sample image may be acquired by inputting the sample image into an encoder in the Student Network.

The feature map refers to an intermediate result processed by specific modules (such as an encoder, a convolution layer, etc.) in a deep learning neural network, which is a dense feature.

At block S302, the third feature information and the fourth feature information are acquired by performing feature extraction on the first feature map.

In the embodiment of the disclosure, after the first feature map is acquired, the third feature information may be acquired by performing feature extraction on the first feature map using the first granularity and the fourth feature information may be acquired by performing feature extraction on the first feature map using the second granularity.

For example, for the first feature map z₁, the third feature information y₁^{c} may be acquired by performing feature extraction on the first feature map z₁ using the first granularity and the fourth feature information y₁^{f} may be acquired using the second granularity.

Further, in the disclosure, before the sample image is input into the Student Network, a first enhanced sample image may be acquired by performing data enhancement on the sample image, and the first enhanced sample image may be input into the Student Network.

Optionally, any method may be selected from a preset set of data enhancement methods may be taken as a first data enhancement method, and data enhancement may be performed on the sample image based on the first data enhancement method to acquire the first enhanced sample image which is input into the Student Network.

For example, for a sample image X, the first data enhancement method t₁ may be selected from a preset set of data enhancement methods, and data enhancement may be performed on the sample image X based on the first data enhancement method t₁ to acquire the first enhanced sample image v₁ which is input into the Student Network.

Further, the first feature map of the first enhanced sample image may be acquired, and the third feature information and the fourth feature information may be acquired by performing feature extraction on the first feature map.

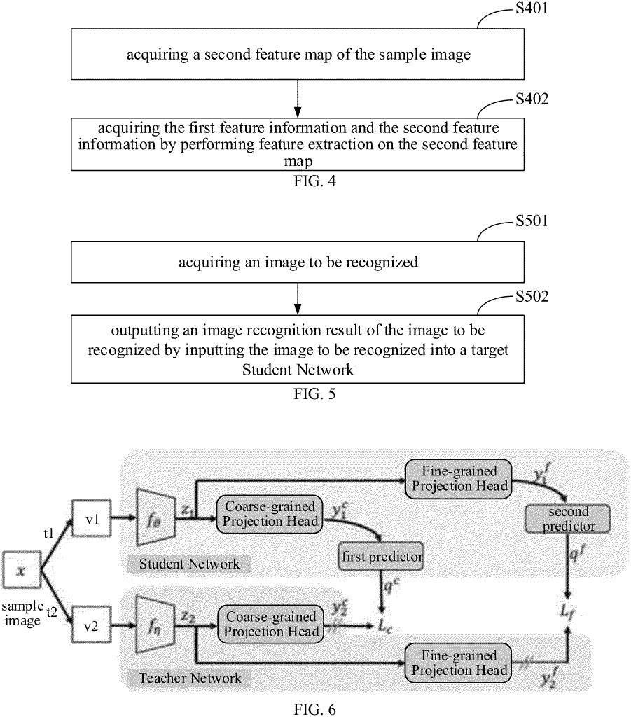

For acquiring the first feature information and the second feature information, as a possible implementation, as illustrated in FIG. 4, on the basis of the above embodiments, the method specifically includes the following blocks.

At block S401, a second feature map of the sample image is acquired.

In the embodiment of the disclosure, the second feature map of the sample image may be acquired by inputting the sample image into an encoder in the Teacher Network.

At block S402, the first feature information and the second feature information are acquired by performing feature extraction on the second feature map.

In the embodiment of the disclosure, after the second feature map is acquired, the first feature information may be acquired by performing feature extraction on the second feature map using the first granularity and the second feature information may be acquired by performing feature extraction on the second feature map using the second granularity.

For example, for the second feature map z₂, the first feature information y₂^{c} may be acquired by performing feature extraction on the second feature map z₂ using the first granularity and the fourth feature information y₂^{f} may be acquired using the second granularity.

Further, in the disclosure, before the sample image is input into the Teacher Network, a second enhanced sample image may be acquired by performing data enhancement on the sample image, and the second enhanced sample image may be input into the Teacher Network.

Optionally, any method may be selected from a preset set of data enhancement methods and taken as a second data enhancement method, and data enhancement may be performed on the sample image based on the second data enhancement method to acquire the second enhanced sample image which is input into the Teacher Network.

The second data enhancement method is inconsistent with the first data enhancement method.

For example, for the sample image X, the second data enhancement method t₂ may be selected from a preset set of data enhancement methods, and data enhancement may be performed on the sample image X based on the second data enhancement method t₂ to acquire the second enhanced sample image v₂ which is input into the Teacher Network.

Further, a second feature map of the second enhanced sample image may be acquired, and the first feature information and the second feature information may be acquired by performing feature extraction on the second feature map.

Further, the Student Network may be updated by performing back propagation recognition on a parameter of the Student Network based on the first loss function and the second loss function.

It needs to be noted that, since the Teacher Network is different from the Student Network, the Teacher Network may not be automatically updated through automatic back propagation, therefore, in order to prevent the Teacher Network from model collapsing, in the disclosure, a delay factor may be acquired, and the Teacher Network may be adjustedbased on the delay factor.

Optionally, the teacher network may be updated by performing exponential moving average recognition on a parameter of the Teacher Network based on the delay factor.

Exponential moving average recognition, also referred to as exponential smoothing, refers to a prediction method for performing different weighted assignments on an actual value of a previous period and a predicted value (an estimated value) to acquire an exponential smoothing value as a predicted value of a next period.

As a possible implementation, a first parameter of an encoder in the Teacher Network, a second parameter of a feature extraction module using the first granularity, and a third parameter of a feature extraction module using the second granularity may be adjusted.

Optionally, for the first parameter, it may be acquired by the following formula:

$$η = m ⋅ η + \left(1 - m\right) ⋅ θ$$

where, m is a delay factor, η is the first parameter, and θ is a parameter of an encoder of the Student Network.

For the second parameter, it may be acquired by the following formula:

$${h}_{η}^{c p} = m ⋅ {h}_{η}^{c p} + \left(1 - m\right) ⋅ {h}_{θ}^{c p}$$

where,

$${\text{h}}_{θ}^{\text{cp}}$$

is the second parameter.

For the third parameter, it may be acquired by the following formula:

$${h}_{η}^{f p} = m ⋅ {h}_{η}^{f p} + \left(1 - m\right) ⋅ {h}_{θ}^{f p}$$

where,

$${\text{h}}_{θ}^{\text{fp}}$$

is the third parameter.

Based on the method for training a Student Network in the embodiment of the disclosure, first feature information and second feature information may be acquired using a Teacher Network for performing multi-granularity feature extraction, and first prediction feature information and second prediction feature information may be acquired using a Student Network for performing multi-granularity feature extraction, and further first feature information and second feature information may be predicted based on the first prediction feature information and the second prediction feature information, and a parameter of the Student Network and a parameter of the Teacher Network may be adjusted based on a prediction result until a training termination condition is satisfied, and the Student Network after last parameter adjustment may be taken as a target Student Network, so as to avoid model collapsing in a training process, thereby ensuring a training effect to obtain a trained target Student Network, which further improves a training effect of the Student Network.

A method for recognizing an image in the embodiment of the disclosure is described with reference to attached drawings.

FIG. 5 is a flow chart illustrating a method for recognizing an image according to a fifth embodiment of the disclosure. It should be noted that, an execution subject of the method for recognizing an image in the embodiment may be an apparatus for recognizing an image. The apparatus for recognizing an image may be specifically a hardware device or a software in a hardware device, etc. The hardware device may be a terminal device, a server, etc.

As illustrated in FIG. 5, the method for recognizing an image provided in the embodiment includes the following blocks.

At block S501, an image to be recognized is acquired.

The image to be recognized may be any image to be recognized.

At block S502, an image recognition result of the image to be recognized is output by inputting the image to be recognized into a target Student Network.

In the embodiment of the disclosure, an image to be recognized may be input into a target Student Network, first feature information may be acquired by performing feature extraction on the image to be recognized on a first granularity with the target Student Network, and second feature information may be acquired by performing feature extraction on the image to be recognized on a second granularity, and further an image recognition result of the image to be recognized may be acquired based on the first feature information and the second feature information.

Based on the method for recognizing an image in the embodiment of the disclosure, an image to be recognized is acquired, and further an image recognition result of the image to be recognized is output by inputting the image to be recognized into a target Student Network, so that the image to be recognized may be input into a trained Student Network to acquire an image recognition result that may reflect a region-level feature and may reflect a pixel-level feature, which enhances the accuracy and reliability of the image recognition result.

It needs to be noted that, as illustrated in FIG. 6, a Deep Coarse-grained and Fine-grained Representations (Deep CFR) system including a Student Network and a Teacher Network is provided.

A training process of the Deep CFR is described.

Optionally, for a sample image X, a first data enhancement method t₁ and a second data enhancement method t₂ may be selected from a preset set t of data enhancement methods, and data enhancement may be performed on the sample image X based on the first data enhancement method t₁ to acquire a first enhanced sample image v₁ which is input into the Student Network, and data enhancement may be performed on the sample image X based on the second data enhancement method t₂ to acquire a second enhanced sample image v₂ which is input into the Teacher Network.

Further, a first feature map z₁ may be acquired based on the first enhanced sample image v₁, and a second feature map z₂ may be acquired based on the second enhanced sample image v₂.

Further, for the Student Network, third feature information y₁^{c} may be acquired by performing coarse-grained feature extraction on the first feature map z₁ with a coarse-grained feature extraction module, and fourth feature information y₁^{f} may be acquired by performing fine-grained feature extraction on the first feature map z₁ with a fine-grained feature extraction module. For the Teacher Network, first feature information y₂^{c} may be acquired by performing coarse-grained feature extraction on the second feature map z₂ with a coarse-grained feature extraction module, and second feature information y₂^{f} may be acquired by performing fine-grained feature extraction on the second feature map z₂ with a fine-grained feature extraction module.

Further, the third feature information y₁^{c} may be input into a first predictor, and the first prediction feature information q^{c} may be acquired by performing prediction mapping of the third feature information y₁^{c} to the first feature information, and the fourth feature information y₁^{f} may be input into a second predictor, and the second prediction feature information q^{f} may be acquired by performing prediction mapping of the fourth feature information y₁^{f} to the second feature information. The first predictor and the second predictor are correspondingly connected to the coarse-grained feature extraction module and the fine-grained feature extraction module in the Student Network.

Further, a first loss function L_{c} may be acquired based on the first prediction feature information q^{c} and the first feature information y₂^{c}, and a second loss function L_{f} may be acquired based on the second prediction feature information q^{f} and the second feature information y₂^{f}.

Further, a target Student Network may be acquired by adjusting the Student Network based on the first loss function L_{c} and the second loss function L_{f}.

In the Student Network and the Teacher Network, a feature extraction module using a second granularity is illustrated in FIG. 7.

A residual module is formed by one 1 × 1 Conv (convolutional layer), one 3 × 3 Conv and one 1 × 1 Conv, and a channel for inputting a feature map is reduced by one 1 × 1 Conv, to save a video memory and a computation overhead, and obtain a feature map z^∈R^(C×H×W).

Further, a codebook consisting of K learnable visual words may be defined, that is, C={c_1,c_2,...,c_K}. For each visual word, residues of respective positions and the visual word may be weighted and accumulated by the following formula:

$${r}_{k} = {\sum }_{i} {a}_{k} \left({\hat{z}}_{i}\right) \left({\hat{z}}_{i} - {c}_{k}\right)$$

$${a}_{k} \left({\hat{z}}_{i}\right) = \frac{\text{exp} \left(- \frac{1}{δ μ} {\left‖{\hat{z}}_{i} - {c}_{k}\right‖}_{2}^{2}\right)}{{Σ}_{j} \text{exp} \left(- \frac{1}{δ μ} {\left‖{\hat{z}}_{i} - {c}_{j}\right‖}_{2}^{2}\right)}$$

where, aₖ(ẑᵢ) is a soft-weight assignment of a feature vector z_{¡} for a visual word cₖ, and δµ is an adaptive temperature item, configured to control a smoothness degree of the soft-weight assignment, and µ is a mean square distance between the feature vector and the nearest visual word, and updated in a moving average manner, and δ is a basic temperature value.

Further, after all coding residues rₖ are acquired, the residues are normalized by L2, and the normalized processing results are concatenated into the following high-dimensional vector y^{f}:

$${y}^{f} = C o n c a t \left(N o r m \left({r}_{1}\right) , N o r m \left({r}_{2}\right) ... , N o r m \left({r}_{K}\right)\right)$$

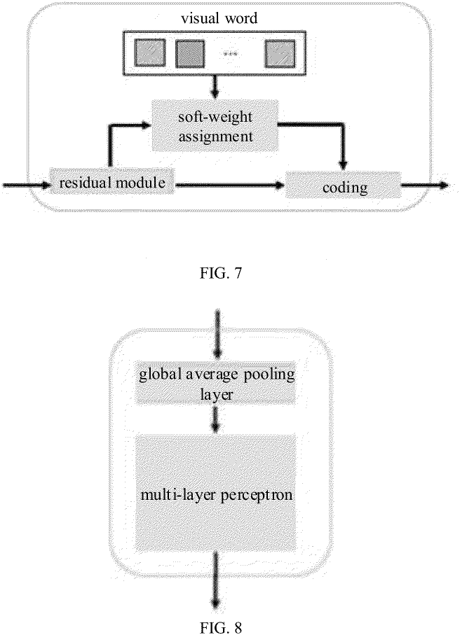

In the Student Network and the Teacher Network, a feature extraction module using a first granularity (Coarse-grained feature extraction module, also referred to as Coarse-grained Projection Head) is illustrated in FIG. 8, where, “//” represents a gradient termination operation.

The specific process is illustrated in the following formula by a global average pooling layer and a multi-layer perceptron:

$${y}^{c} = M L P \left(G A P \left(z\right)\right)$$

where, GAP (·) represents the global average pooling layer, and MLP (·) represents the multi-layer perceptron.

Therefore, in the disclosure, the sample image is enhanced twice, and the two enhanced images are input into two coding networks for training through a student-teacher architecture. A Student Network is trained to predict two features output by a teacher network, and further a target Student Network is acquired by adjusting the parameter of the Student Network, so that a trained target Student Network may acquire a region-level feature of the image by focusing on a salient region, and further may acquire a pixel-level feature of the image, which avoids an inaccurate image recognition result caused due to ignoring other important regions of the image and improves a training effect of the Student Network. Further, an image recognition result that may reflect the region-level feature and may reflect the pixel-level feature is acquired, which enhances the accuracy and reliability of an image recognition result.

The acquisition, storage, and application of the user personal information involved in the technical solution of the disclosure comply with relevant laws and regulations, and do not violate public order and good customs.

Corresponding to the method for training a Student Network provided in the above embodiments, an apparatus for training a Student Network is further provided in the embodiment of the disclosure. Since the apparatus for training a Student Network provided in the embodiments of the disclosure corresponds to the method for training a Student Network provided in the above embodiments of the disclosure, the implementation of the method for training a Student Network is also applied to an apparatus for training a Student Network provided in the embodiment, which will not be described in the embodiment.

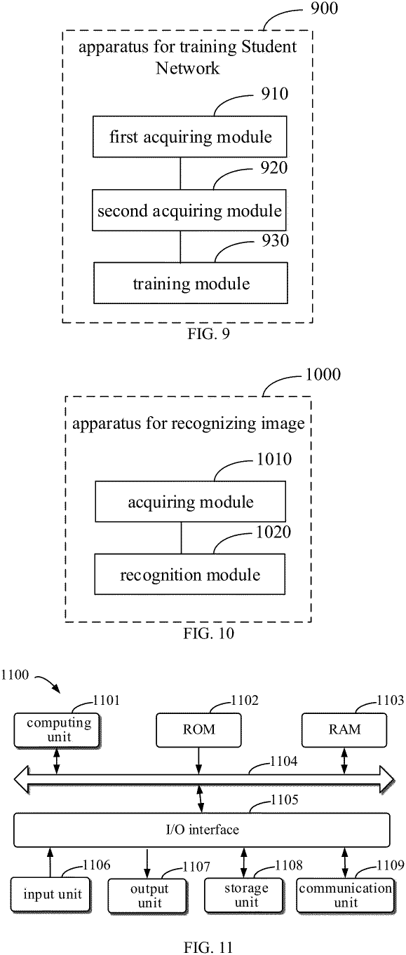

FIG. 9 is a block diagram illustrating an apparatus for training a Student Network in one embodiment of the disclosure.

As illustrated in FIG. 9, the apparatus 900 for training a Student Network may include a first acquiring module 910, a second acquiring module 920 and a training module 930.

The first acquiring module 910 is configured to acquire first prediction feature information of a sample image on a first granularity and second prediction feature information of the sample image on a second granularity by inputting the sample image into a Student Network, in which the first granularity is different from the second granularity.

The second acquiring module 920 is configured to acquire first feature information of the sample image on the first granularity and second feature information of the sample image on the second granularity by inputting the sample image into a Teacher Network.

The training module 930 is configured to acquire a target Student Network by adjusting the Student Network based on the first prediction feature information, the second prediction feature information, the first feature information and the second feature information.

The first acquiring module 910 is further configured to: acquire third feature information of the sample image on the first granularity and fourth feature information of the sample image on the second granularity by performing feature extraction of the sample image; acquire the first prediction feature information by performing prediction mapping on the third feature information to the first feature information; and acquire the second prediction feature information by performing prediction mapping of the fourth feature information to the second feature information.

The first acquiring module 910 is further configured to: acquire a first feature map of the sample image; and acquire the third feature information and the fourth feature information by performing feature extraction on the first feature map.

The first acquiring module 910 is further configured to: acquire a first enhanced sample image by performing data enhancement on the sample image, and input the first enhanced sample image into the Student Network.

The second acquiring module 920 is further configured to: acquire the first feature information and the second feature information of the sample image by performing feature extraction on the sample image.

The second acquiring module 920 is further configured to: acquire a second feature map of the sample image; and acquire the first feature information and the second feature information by performing feature extraction on the second feature map.

The second acquiring module 920 is further configured to: acquire a second enhanced sample image by performing data enhancement on the sample image, and input the second enhanced sample image into the Teacher Network.

The training module 930 is further configured to: acquire a first loss function of the Student Network based on the first prediction feature information and the first feature information; acquire a second loss function of the Student Network based on the second prediction feature information and the second feature information; and adjust the Student Network based on the first loss function and the second loss function.

The training module 930 is further configured to: update the Student Network by performing back propagation recognition on a parameter of the Student Network based on the first loss function and the second loss function.

The training module 930 is further configured to: acquire a delay factor, and adjust the Teacher Network based on the delay factor.

The training module 930 is further configured to: update the Teacher network by performing exponential moving average recognition on a parameter of the Teacher Network based on the delay factor.

Based on the apparatus for training a Student Network in the embodiment of the disclosure, first prediction feature information of the sample image on a first granularity and second prediction feature information of the sample image on a second granularity are acquired by inputting the sample image into a Student Network, and first feature information of the sample image on the first granularity and second feature information of the sample image are acquired on the second granularity by inputting the sample image into a Teacher Network, and further a target Student Network is acquired by adjusting the Student Network based on the first prediction feature information, the second prediction feature information, the first feature information and the second feature information, so that a trained target Student Network may acquire a region-level feature of the image by focusing on a salient region, and further may acquire a pixel-level feature of the image, which avoids an inaccurate image recognition result caused due to ignoring other important regions of the image and improves a training effect of the Student Network.

Corresponding to the method for recognizing an image provided in the above embodiments, an apparatus for recognizing an image is further provided in the embodiment of the disclosure. Since the apparatus for recognizing an image provided in the embodiments of the disclosure corresponds to the method for recognizing an image provided in the above embodiments of the disclosure, the implementation of the method for recognizing an image is also applied to the apparatus for recognizing an image provided in the embodiment, which will not be described in the embodiment.

FIG. 10 is a block diagram illustrating an apparatus for recognizing an image in one embodiment of the disclosure.

As illustrated in FIG. 10, the apparatus 1000 for recognizing an image includes an acquiring module 1010 and a recognition module 1020.

The acquiring module 1010 is configured to acquire an image to be recognized; and the recognition module 1020 is configured to output an image recognition result of the image to be recognized by inputting the image to be recognized into a target Student Network, the target Student Network is acquired by the method for training a Student Network as described in the first aspect of embodiments.

Based on the apparatus for recognizing an image in the embodiment of the disclosure, an image to be recognized is acquired, and further an image recognition result of the image to be recognized is output by inputting the image to be recognized into a target Student Network, so that the image to be recognized may be input into a trained target Student Network to acquire an image recognition result that may reflect a region-level feature and may reflect a pixel-level feature, which enhances the accuracy and reliability of the image recognition result.

According to the embodiment of the disclosure, an electronic device, a readable storage medium and a computer program product are further provided in the disclosure.

FIG. 11 illustrates a block diagram of an example electronic device 1100 configured to implement the embodiment of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 11, a device 1100 includes a computing unit 1101, configured to execute various appropriate actions and processes according to a computer program stored in a read-only memory (ROM) 1102 or loaded from a storage unit 1108 to a random access memory (RAM) 1103. In a RAM 1103, various programs and data required by an operation of a device 1100 may be further stored. The computing unit 1101, the ROM 1002, and the RAM 1103 are connected to each other through a bus 1104. An input/output (I/O) interface 1105 is also connected to a bus 1104.

Several components in the device 1100 are connected to the I/O interface 1105, and include: an input unit 1106, for example, a keyboard, a mouse, etc.; an output unit 1107, for example, various types of displays, speakers, etc.; a storage unit 1108, for example, a magnetic disk, an optical disk, etc.; and a communication unit 1109, for example, a network card, a modem, a wireless communication transceiver, etc. The communication unit 1109 allows the device 1100 to exchange information/data with other devices over a computer network such as the Internet and/or various telecommunication networks.

The computing unit 1101 may be various general and/or dedicated processing components with processing and computing ability. Some examples of the computing unit 1101 include but not limited to a central processing unit (CPU), a graphs processing unit (GPU), various dedicated artificial intelligence (AI) computing chips, various computing units running a machine learning model algorithm, a digital signal processor (DSP), and any appropriate processor, controller, microcontroller, etc. The computing unit 1101 performs various methods and processings as described above, for example, a method for training a Student Network and a method for recognizing an image. For example, in some embodiments, the method for training a Student Network as described in a first aspect of the disclosure and the method for recognizing an image as described in a second aspect of the disclosure may be further achieved as a computer software program, which is physically contained in a machine readable medium, such as a storage unit 1108.

In some embodiments, a part or all of the computer program may be loaded and/or installed on the device 1100 through a ROM 1102 and/or a communication unit 1109. When the computer program is loaded on a RAM 1103 and performed by a computing unit 1101, one or more blocks in the method for training a Student Network and the method for recognizing an image may be performed. Alternatively, in other embodiments, a computing unit 1101 may be configured to perform the method for training a Student Network as described in a first aspect of embodiments of the disclosure or the method for recognizing an image as described in a second aspect of embodiments of the disclosure in other appropriate ways (for example, by virtue of a firmware).

Various implementation modes of the systems and technologies described above may be achieved in a digital electronic circuit system, a field programmable gate array (FPGA), an application-specific integrated circuit (ASIC), an application specific standard product (ASSP), a system-on-chip (SOC) system, a complex programmable logic device, a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of a plurality of programming languages. The programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be performed completely or partly on the machine, performed partly on the machine as an independent software package and performed partly or completely on the remote machine or server.

In the context of the disclosure, a machine-readable medium may be a tangible medium that may contain or store a program intended for use in or in conjunction with an instruction execution system, apparatus, or device. A machine readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a speech input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relationship between the client and the server is generated by computer programs running on the corresponding computer and having a client-server relationship with each other. A server may be a cloud server, and further may be a server of a distributed system, or a server in combination with a blockchain.

A computer program product including a computer program is provided in the disclosure, the computer program is configured to implement the method for training a Student Network and the method for recognizing an image when performed by a processor.

It should be understood that, various forms of procedures shown above may be configured to reorder, add or delete blocks. For example, blocks described in the disclosure may be executed in parallel, sequentially, or in different orders, as long as the desired result of the technical solution disclosed in the present disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of the present disclosure.

What is claimed is:

1. A method for training a Student Network, comprising:
acquiring first prediction feature information of a sample image on a first granularity and second prediction feature information of the sample image on a second granularity by inputting the sample image into a Student Network, wherein, the first granularity is different from the second granularity;
acquiring first feature information of the sample image on the first granularity and second feature information of the sample image on the second granularity by inputting the sample image into a Teacher Network; and
acquiring a target Student Network by adjusting the Student Network based on the first prediction feature information, the second prediction feature information, the first feature information and the second feature information.

2. The method of claim 1, wherein, acquiring the first prediction feature information of the sample image on the first granularity and the second prediction feature information of the sample image on the second granularity by inputting the sample image into the Student Network, comprises:
acquiring third feature information of the sample image on the first granularity and fourth feature information of the sample image on the second granularity by performing feature extraction on the sample image;
acquiring the first prediction feature information by performing prediction mapping of the third feature information to the first feature information; and
acquiring the second prediction feature information by performing prediction mapping of the fourth feature information to the second feature information.

3. The method of claim 2, wherein, acquiring the third feature information of the sample image on the first granularity and the fourth feature information of the sample image on the second granularity by performing feature extraction on the sample image, comprises:
acquiring a first feature map of the sample image; and
acquiring the third feature information and the fourth feature information by performing feature extraction on the first feature map.

4. The method of claim 1, further comprising:
acquiring a first enhanced sample image by performing data enhancement on the sample image, and inputting the first enhanced sample image into the Student Network.

5. The method of claim 1, wherein, acquiring the first feature information of the sample image on the first granularity and the second feature information of the sample image on the second granularity by inputting the sample image into the Teacher Network, comprises:
acquiring the first feature information and the second feature information of the sample image by performing feature extraction on the sample image.

6. The method of claim 5, wherein, acquiring the first feature information and the second feature information of the sample image by performing feature extraction on the sample image, comprises:
acquiring a second feature map of the sample image; and
acquiring the first feature information and the second feature information by performing feature extraction on the second feature map.

7. The method of claim 1, further comprising:
acquiring a second enhanced sample image by performing data enhancement on the sample image, and inputting the second enhanced sample image into the Teacher Network.

8. The method of claim 1, wherein, adjusting the Student Network based on the first prediction feature information, the second prediction feature information, the first feature information and the second feature information, comprises:
acquiring a first loss function of the Student Network based on the first prediction feature information and the first feature information;
acquiring a second loss function of the Student Network based on the second prediction feature information and the second feature information; and
adjusting the Student Network based on the first loss function and the second loss function.

9. The method of claim 8, wherein, adjusting the Student Network based on the first loss function and the second loss function, comprises:
updating the Student Network by performing back propagation recognition on a parameter of the Student Network based on the first loss function and the second loss function.

10. The method of claim 1, further comprising:
acquiring a delay factor, and adjusting the Teacher Network based on the delay factor.

11. The method of claim 10, wherein, adjusting the Teacher Network based on the delay factor, comprises:
updating the Teacher network by performing exponential moving average (EMA) recognition on a parameter of the Teacher Network based on the delay factor.

12. A method for recognizing an image, comprising:
acquiring an image to be recognized; and
outputting an image recognition result of the image by inputting the image into a target Student Network, wherein, the target Student Network is acquired by the method of claim 1.

13. An electronic device, comprising a processor and a memory;
wherein, the processor runs a program corresponding to an executable program code by reading the executable program code stored in the memory, to perform the following:
acquiring first prediction feature information of a sample image on a first granularity and second prediction feature information of the sample image on a second granularity by inputting the sample image into a Student Network, wherein, the first granularity is different from the second granularity;
acquiring first feature information of the sample image on the first granularity and second feature information of the sample image on the second granularity by inputting the sample image into a Teacher Network; and
acquiring a target Student Network by adjusting the Student Network based on the first prediction feature information, the second prediction feature information, the first feature information and the second feature information.

14. The electronic device of claim 13, wherein, acquiring the first prediction feature information of the sample image on the first granularity and the second prediction feature information of the sample image on the second granularity by inputting the sample image into the Student Network, comprises:
acquiring third feature information of the sample image on the first granularity and fourth feature information of the sample image on the second granularity by performing feature extraction on the sample image;
acquiring the first prediction feature information by performing prediction mapping of the third feature information to the first feature information; and
acquiring the second prediction feature information by performing prediction mapping of the fourth feature information to the second feature information.

15. The electronic device of claim 13, wherein the processor is further caused to perform:
acquiring a first enhanced sample image by performing data enhancement on the sample image, and inputting the first enhanced sample image into the Student Network.

16. The electronic device of claim 13, wherein, acquiring the first feature information of the sample image on the first granularity and the second feature information of the sample image on the second granularity by inputting the sample image into the Teacher Network, comprises:
acquiring the first feature information and the second feature information of the sample image by performing feature extraction on the sample image.

17. The electronic device of claim 13, wherein the processor is further caused to perform:
acquiring a second enhanced sample image by performing data enhancement on the sample image, and inputting the second enhanced sample image into the Teacher Network.

18. The electronic device of claim 13, wherein, adjusting the Student Network based on the first prediction feature information, the second prediction feature information, the first feature information and the second feature information, comprises:
acquiring a first loss function of the Student Network based on the first prediction feature information and the first feature information;
acquiring a second loss function of the Student Network based on the second prediction feature information and the second feature information; and
adjusting the Student Network based on the first loss function and the second loss function.

19. The electronic device of claim 13, wherein the processor is further caused to perform:
acquiring a delay factor, and adjusting the Teacher Network based on the delay factor.

20. A computer readable storage medium stored with a computer program thereon, wherein, when the computer program is performed by a processor, the processor is caused to perform the method of claim 1.
